(19) United States
(12) Patent Application Publication
(10) Pub. No.: US 2003/0163750 A1
(43) Pub. Date: Aug. 28, 2003

(54) Clock grid skew reduction technique using biasable delay drivers

(76) Inventors: Pradeep Trivedi, Sunnyvale, CA (US); Lynn Ooi, Santa Clara, CA (US); Gin Yee, Sunnyvale, CA (US)

Correspondence Address: ROSENTHAL & OSHA L.L.P. / SUN, 1221 MCKINNEY, SUITE 2800, HOUSTON, TX, 77010, US

(21) Appl. No.: 10/082,892

(22) Filed: Feb. 26, 2002

(51) Int. Cl. G06F 1/04

(52) U.S. Cl. 713/503

(57) ABSTRACT

A clock grid skew reduction technique that uses one or more biasable delay drivers to compensate for unbalanced loading and/or RC wire delay induced skew is provided. The biasable delay driver has a size that may be varied depending on a delay amount of a signal from a clock source to an input of the biasable delay driver. Depending on the delay amount, the biasable delay driver may be either sized up or sized down to modulate delay in order to reduce or eliminate skew between the clock signal at the input of the biasable delay driver and the clock signal at another point in a circuit.

### BACKGROUND OF INVENTION

As shown in FIG. 1, a typical computer system (10) has, among other components, a microprocessor (12), one or more forms of memory (14), integrated circuits (16) having specific functionalities, and peripheral computer resources (not shown), e.g., monitor, keyboard, software programs, etc. These components communicate with one another via communication paths (19), e.g., wires, buses, etc., to accomplish the various tasks of the computer system (10).

In order to properly accomplish such tasks, the computer system (10) relies on the basis of time to coordinate its various operations. To this end, a crystal oscillator (18) generates a reference clock signal (referred to and known in the art as “system clock” and shown in FIG. 1 as sys_clk) to various parts of the computer system (10). However, modem microprocessors and other integrated circuits typically operate at frequencies significantly higher than that of the signals most crystal oscillators can provide, and thus, another clock source, such as a phase locked loop (“PLL”) (20) is used to phase align the reference clock with an internally generated clock of the PLL (20). It follows that one of the main objectives of high speed microprocessor design is to properly distribute a clock signal, e.g., a chip clock (shown in FIG. 1 as chip_clk), from a source, e.g., PLL (20), to clock controlled elements in the microprocessor.

FIG. 2 shows a clock distribution network (22) for a microprocessor (12). A reference clock (shown in FIG. 2 as ref_clk), generated from outside the microprocessor (12), serves as an input to a PLL (20). Essentially, the PLL (20) uses the reference clock to generate a high frequency clock signal, i.e., a chip clock, and then uses feedback to maintain a specific phase relationship between its output, the chip clock (shown in FIG. 2 as chip_clk), and the reference clock. The chip clock from the PLL (20) is then distributed to one or more clock headers/buffers (17) that distribute the chip clock to a global clock grid (21). The global clock grid (21) feeds the chip clock to another set of clock headers/buffers (18) that distribute the chip clock to, for example, local clock grids (24) and a feedback loop (26) that feeds the chip clock back to the PLL (20). Further, the local clock grids (24) feed the chip clock to base components of the microprocessor (12), such as latches (23) and flip-flops (28).

As a clock signal, such as the chip clock shown in FIG. 2, propagates to the various parts and components of a microprocessor, one or more types of system variations may alter the behavior and/or integrity of the clock signal. Common system variations include, but are not limited to, capacitive noise, inductive noise, voltage variations, temperature variations, process variations, unbalanced wire loads, and RC wire delays. Due to these and other variations across a microprocessor, a particular clock signal may arrive at different clock controlled elements of the microprocessor at different times. This difference in the arrival of a clock signal at different clock controlled elements is referred to and known in the art as “skew.”

Generally, skew is defined as the difference in the arrival time of a particular signal's active edge at two different clock controlled elements. In other words, skew results when the delay from a common source through two different paths connected to two different clock controlled elements is not matched. For example, in FIG. 3a, a global clock grid header (17) outputs a clock signal (shown in FIG. 3a as clk_0) that propagates to two different paths (32, 34) within a global clock grid (21 in FIG. 2). The first path (32) is subject to a first delay (36) and the second path (34) is subject to a second delay (38). The first and second delays (36, 38) may be induced by various variations across an integrated circuit. The first delayed clock signal (shown in FIG. 3a as clk_1) serves as an input to a first local clock grid header (18), and the second delayed clock signal (shown in FIG. 3a as clk_2) serves as an input to a second local clock grid header (18). Because the first delay (36) and second delay (38) may not be equal, the first and second local clock grid headers (18) are clocked, i.e., triggered, at different times in spite of the expectation that they should be clocked at the same time due to synchronous system design as exemplified by the common data inputs (shown in FIG. 3a as data) to elements (40, 42) controlled by the clock signal outputs from the first and second local clock grid headers (18).

FIG. 3b shows a timing diagram of the circuit shown in FIG. 3a. The first delayed clock signal (represented in FIG. 3b as elk 1) has a first delay (44) with respect to the global clock grid header (17) generated clock signal (represented in FIG. 3b as clk_0). The second delayed clock signal (represented in FIG. 3b as elk 2) has a second delay (46) with respect to the global clock grid header (17) generated clock signal. As shown in FIG. 3b, the first delay (44) and second delay (46) are not equal, and thus skew results (48) between the first delayed clock signal and the second delayed clock signal.

Due to skew, elements that are designed to synchronously operate with a clock signal instead function off different time references-a generally undesirable effect. In the case of a min-time situation, i.e., where there is a race between a data signal and a clock signal to some latching point, the presence of skew among the min-time paths may effectively cause a particular integrated circuit to become unusable. Notwithstanding the expensive and undesirable effects of such min-time skew, skew, in a general sense, may cause, among other things, performance degradation, inaccurate operation, and malfunction.

### SUMMARY OF INVENTION

According to one aspect of the present invention, an integrated circuit comprises a clock source that outputs a clock signal, where the clock signal propagates down a first path; and a first biasable delay driver that inputs the clock signal at a point on the first path, where the first biasable delay driver is selectively sized based on a delay of the clock signal from the clock source to the point on the first path.

According to another aspect, an integrated circuit comprises means for propagating a clock signal from a clock source to a point on a signal path; and means for inputting the clock signal at the point and outputting a delay biased clock signal based on a delay of the clock signal from the clock source to the point.

According to another aspect, a method for reducing clock skew comprises determining a first delay of a clock signal from a clock source to a point on a first path, where the clock signal propagates from the clock source to the point on the first path; and selectively sizing a first biasable delay driver depending on the first delay, where the first biasable delay driver inputs the clock signal at the point on the first path.

According to another aspect, a computer system comprises a processor; a memory; and instructions, residing in the memory and executable by the processor, for: determining a first delay of a clock signal from a clock source to a point on a first path, wherein the clock signal propagates from the clock source to the point on the first path; and selectively sizing a first biasable delay driver depending on the first delay, wherein the first biasable delay driver inputs the clock signal at the point on the first path.

According to another aspect, a computer-readable medium, having recorded therein instructions executable by processing, comprises instructions for: determining a first delay of a clock signal from a clock source to a point on a first path, wherein the clock signal propagates from the clock source to the point on the first path; and selectively sizing a first biasable delay driver depending on the first delay, wherein the first biasable delay driver inputs the clock signal at the point on the first path.

Other aspects and advantages of the invention will be apparent from the following description and the appended claims.

### BRIEF DESCRIPTION OF DRAWINGS

FIG. 1 shows a typical computer system.

FIG. 2 shows a typical clock distribution network.

FIG. 3a shows a portion of a clock grid that induces skew.

FIG. 3b shows a timing diagram in accordance with the portion of the cock grid shown in FIG. 3a.

FIG. 4a shows a portion of a clock grid that is subject to unbalanced loading induced skew.

FIG. 4b shows a portion of a clock grid that is subject to RC wire delay induced skew.

FIG. 5a shows a circuit in accordance with an embodiment of the present invention.

FIG. 5b shows a circuit in accordance with another embodiment of the present invention.

FIG. 5c shows a biasable delay driver in accordance with the embodiments shown in FIGS. 5a and 5b.

FIG. 5d shows a timing diagram in accordance with an embodiment of the present invention.

FIG. 6 shows a flow process in accordance with an embodiment of the present invention.

FIG. 7 shows a flow process in accordance with an embodiment of the present invention.

FIG. 8 shows a computer system in accordance with an embodiment of the present invention.

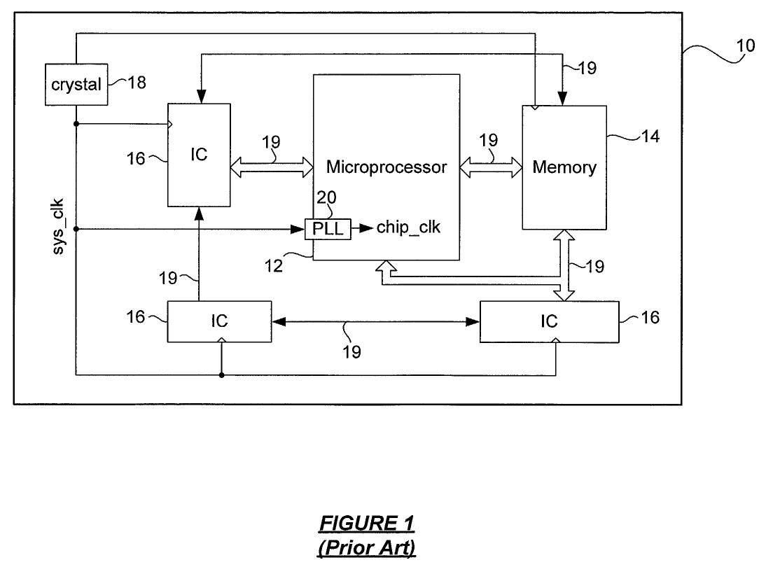

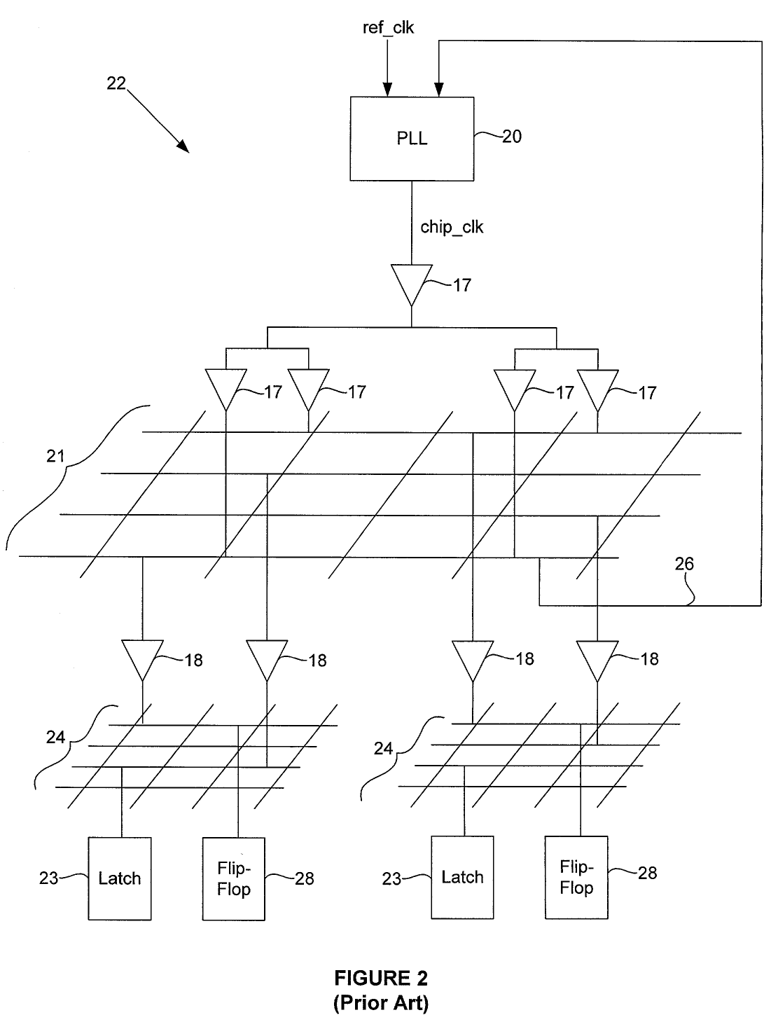

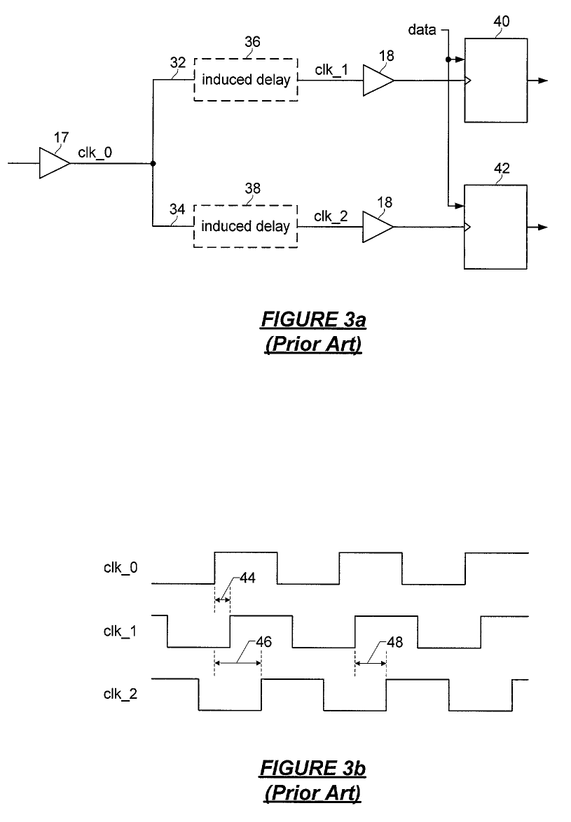

### DETAILED DESCRIPTION

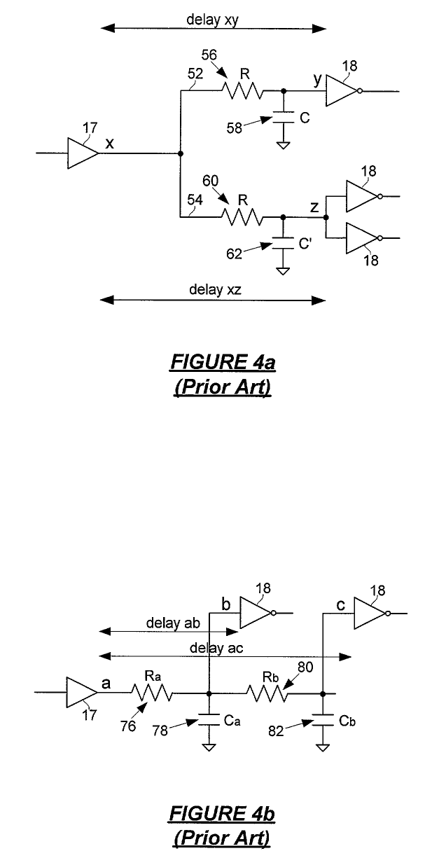

Two types of skew inducing behavior are unbalanced loading and RC wire delays. FIG. 4a shows a portion of a clock grid that is subject to unbalanced loading induced skew. In FIG. 4a, the global clock grid header (17) outputs a signal that propagates to two different loaded paths (52, 54) within a global clock grid. Each path's load is formed by a resistive component and a capacitive component. The first loaded path (52) experiences some resistance (56) and capacitance (58) (shown in FIG. 4a as C). The second loaded path (54) also experiences some resistance (60) and capacitance (62) (shown in FIG. 4a as C′). Because it is extremely difficult to equally divide the load among the various paths of the clock grid, there is a likely probability that the load of the first loaded path (54) and the load of the second loaded path (56) are not equal, i.e., are “unbalanced.” This can be more clearly evidenced by the fact that the first loaded path (52) is subject to a gate capacitance of one local clock grid header (18), whereas the second loaded path (54) is subject to the gate capacitances of two local clock grid headers (18).

Such unbalanced loading among the two loaded paths (52, 54) results in a difference in delays between the global clock grid header (17) output (shown in FIG. 4a as x) and the local clock grid header (18) input (shown in FIG. 4a as y) at the end of the first loaded path (52) and between the global clock grid header (17) output and the local clock grid headers' (18) inputs (shown in FIG. 4a as z) at the end of the second loaded path (54). Thus, due to this difference in delay, skew results between the clock signal at the input of the local clock grid header (18) at the end of the first loaded path (52) and the clock signal at the inputs of the local clock grid headers (18) at the end of the second loaded path (54). This skew propagates, in turn, to the local clock grids and various clock controlled elements.

The second type of skew induced behavior results from RC wire delay on the clock grid. This type of skew occurs due to the failure to match the lengths of paths connecting a clock source to clock controlled element dependent on the clock source output. In other words, if the wire lengths of two paths connecting a clock source output to two different clock controlled elements are not the same, the additional resistance and capacitance contributed by the mismatch on the longer path results in skew.

FIG. 4b shows a portion of a clock grid that is subject to RC wire delay induced skew. In FIG. 4b, the global clock grid header (17) outputs a signal that propagates to a first local clock grid header (18) and a second clock local clock grid header (18). However, as shown in FIG. 4b, the length of the path from the global clock grid header (17) output (shown in FIG. 4b as a) to the first local clock grid header (18) input (shown in FIG. 4b as b) is not equal to the length of the path from the global clock grid header (17) output to the second local clock grid header (18) input (shown in FIG. 4b as c).

Thus, the path from the global clock grid header (17) output to the first local clock grid header (18) input experiences an RC delay that is a function of a first resistance (76) and a first capacitance (78), whereas the path from the global clock grid header (17) output to the second local clock grid header (18) input experiences an RC delay that is a function of the first resistance (76), a second resistance (80), the first capacitance (78), and a second capacitance (82). Because the paths to the first local clock grid header (18) and the second local clock grid header (18) experience different RC delays, skew results between the signals at the first local clock grid header (18) input and the second local clock grid header (18) input. This skew propagates, in turn, to the local clock grids and various clock controlled elements.

To improve performance and reduce skew, the present invention uses a biasable delay driver to compensate for skew on a clock grid that is induced by unbalanced loading and RC wire delays. Thus, embodiments of the present invention relate to a biasable delay driver that is used to reduce clock grid skew that is induced by unbalanced loading. Embodiments of the present invention further relate to a biasable delay driver that is used to reduce skew induced by RC wire delay. Embodiments of the present invention further relate to a method for reducing unbalanced load induced skew. Embodiments of the present invention further relate to a method for reducing RC wire delay induced skew. Embodiments of the present invention further relate to a method for tuning a driver using determined minimum and maximum delay amounts.

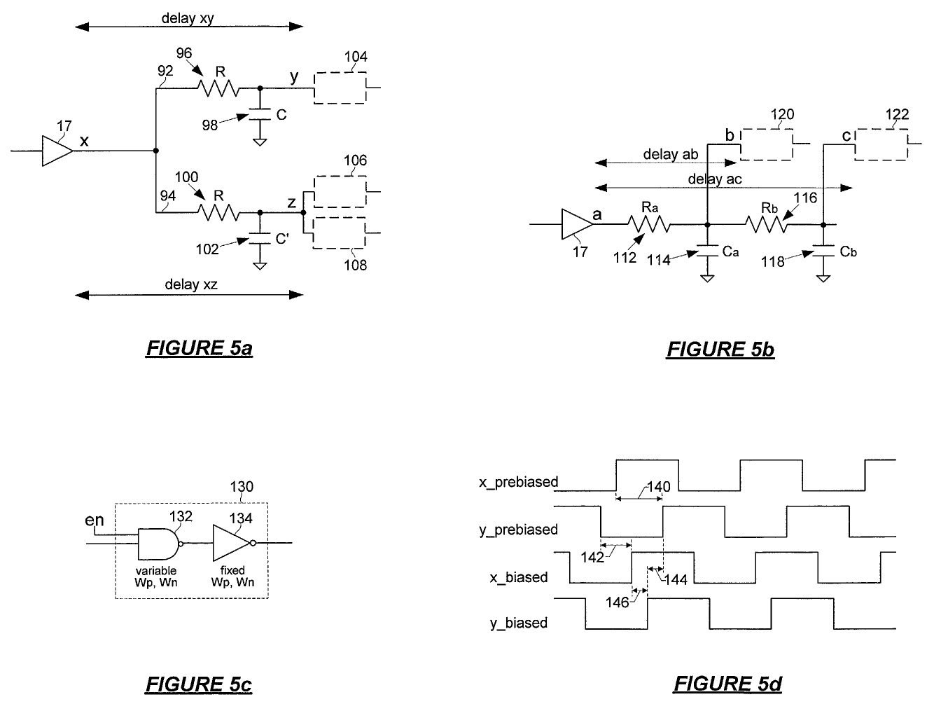

FIG. 5a shows a circuit in accordance with an embodiment of the present invention. In FIG. 5a, the global clock grid header (17) outputs a signal to two different loaded paths (92, 94), where each path is subject to a different RC load as shown by the fact that the first loaded path (92) experiences an RC load formed by some resistance (96) and capacitance (98) (shown in FIG. 5a as C) whereas the second loaded path (94) experiences an RC load formed by some other resistance (100) and capacitance (102) (shown in FIG. 5a as C′). Because this unbalanced loading results in skew between the signal at the end of the first loaded path (92) end (shown in FIG. 5a as y) and the signal at the end of the second loaded path (94) end (shown in FIG. 5a as z), biasable delay drivers (104, 106, 108) are positioned at the ends of the first loaded path (92) and second loaded path (94). A detailed discussion of the biasable delay drivers is discussed below with reference to FIG. 5c.

FIG. 5b shows a circuit in accordance with another embodiment of the present invention. In FIG. 5b, the global clock grid header (17) outputs a signal to two different path ends (shown in FIG. 5b as b and c), where one path is longer than the other. Thus, effectively, the path to the first path end is subject to an RC delay that is a function of a first resistance (112) and a first capacitance (114), whereas the path to the second path end is subject to an RC delay that is a function of the first resistance (112), a second resistance (116), the first capacitance (114), and a second capacitance (118). Because this RC delay mismatch results in skew between the signal at the first path end and the signal at the second path end, biasable delay drivers (120, 122) are positioned at the first and second path ends. A detailed discussion of the biasable delay drivers is discussed below with reference to FIG. 5c.

FIG. 5c shows a biasable delay driver (130) in accordance with the embodiments shown in FIGS. 5a and 5b. The biasable delay driver (130) is formed by a biasable delay NAND gate (132) followed by an inverter (134) having a fixed size. Thus, as shown in FIG. 5c, the size of the NAND gate (132) may be changed by varying Wp, i.e., the width of the PMOS transistor, and/or by varying Wn, i.e., the width of the NMOS transistor, of the NAND gate (132), whereas the Wp and Wn of the inverter (134) is fixed. Thus, the biasable delay driver (130) is characterized to different delays by changing the size of the NAND gate (132). Consequently, the biasable delay driver (130) may be used to compensate for a fast path by sizing down the size of the biasable delay driver (130). Alternatively, the biasable delay driver (130) may be used to compensate for a slow path by sizing up the biasable delay driver (130).

For example, if a first path is subject to a delay that is longer than a delay experienced by a second path, then one of the following remedial measures may be taken to reduce, or eliminate, skew resulting from the mismatched delay: (1) sizing up a biasable delay driver at the end of the first path, i.e., the slower path, (2) sizing down a biasable delay driver at the end of the second path, i.e., the faster path, or (3) sizing up a biasable delay driver at the end of the first path and sizing down a biasable delay driver at the end of the second path.

Those skilled in the art will appreciate that because a fixed size inverter (134) is used at the output of the biasable delay driver (130), the configuration of the biasable delay driver (130) allows for the compensating of skew without changing the drive strength of the biasable delay driver (130). Further, those skilled in the art will appreciate that other embodiments may use a biasable delay driver having equivalent logic functionality.

To further illustrate the function and use of a biasable delay driver, FIG. 5d shows a timing diagram in accordance with an embodiment of the present invention. FIG. 5d shows timing waveforms for a first pre-biased clock signal (represented in FIG. 5d as x_prebiased) and a second pre-biased clock signal (represented in FIG. 5d as y_prebiased). The first pre-biased clock signal and the second pre-biased clock signal may be signals residing at the inputs of two different clock controlled elements that are designed to operate synchronously with respect to a particular clock signal. However, due to unbalanced loading, RC wire delay, or some other delay inducing behavior, there is a relatively large amount of skew (140) between first pre-biased clock signal and the second pre-biased clock signal. This skew (140) is a direct result of the difference in delay along the path ending with the first pre-biased clock signal and along the path ending with the second pre-biased clock signal.

The timing diagram in FIG. 5d shows several ways to reduce or eliminate the skew between the first and second pre-biased clock signals using one or more biasable delay drivers (not shown). In one embodiment, a sized down biasable delay driver may be used to input the first pre-biased clock signal and output a first delay biased clock signal (represented in FIG. 5d as x_biased), where active edges of the first delay biased clock signal arrive after a point in time when the active edges of the first pre-biased clock signal would have arrived if the sized down biasable delay driver had not been used. By slowing down the first delay biased clock signal relative to the first pre-biased clock signal, the skew (142) between the first delay biased clock signal and the second pre-biased clock signal is reduced relative to the amount of skew (140) between the first and second pre-biased clock signals.

In another embodiment, a sized up biasable delay driver may be used to input the second pre-biased clock signal and output a second delay biased clock signal (represented in FIG. 5d as y_biased), where active edges of the second delay biased clock signal arrive before a point in time when the active edges of the second pre-biased clock signal would have arrived if the sized up biasable delay driver had not been used. By speeding up the second delay biased clock signal relative to the second pre-biased clock signal, the skew (144) between the first pre-biased clock signal and the second delay biased clock signal is reduced relative to the amount of skew (140) between the first and second pre-biased clock signals.

In another embodiment, a sized down biasable delay driver and a sized up biasable delay driver may be used in conjunction with each other. In this embodiment, the sized down biasable delay driver generates the first delay biased clock signal, where the first delay biased clock signal has been slowed down relative to the first pre-biased clock signal. The sized up biasable delay driver generates the second delay biased clock signal, where the second clock signal has been sped up relative to the second pre-biased signal. Using this approach, the amount of skew (146) between the first and second delay biased clock signals is even further reduced.

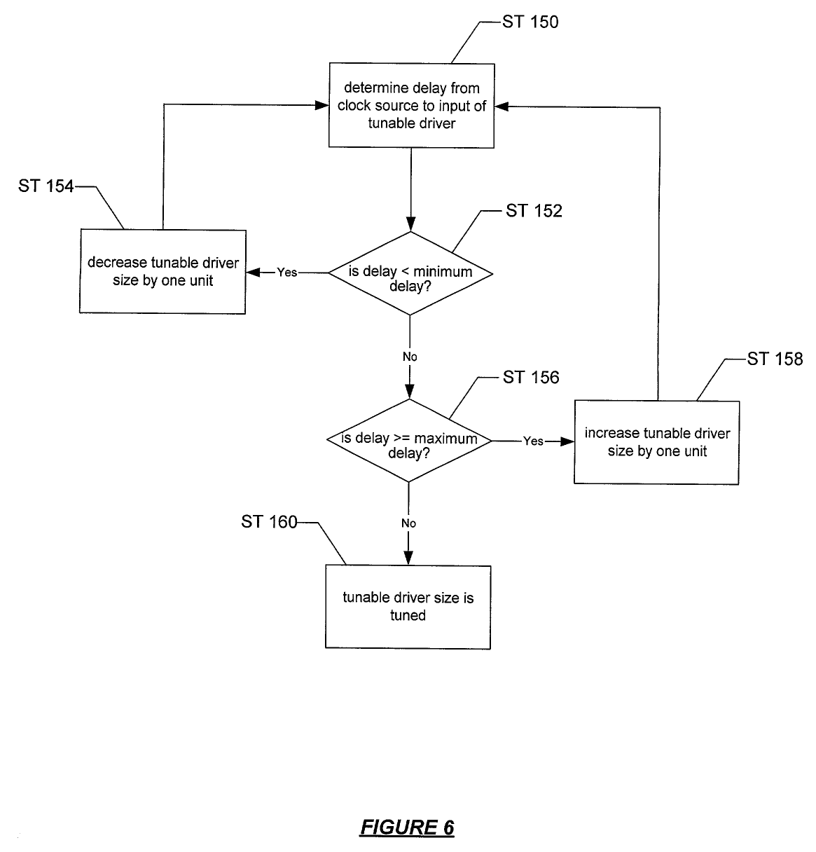

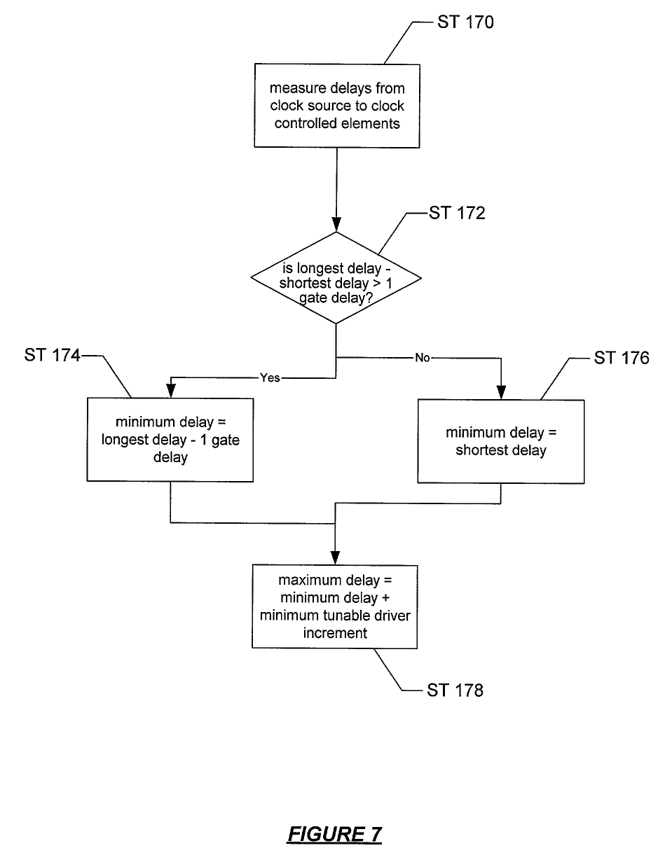

In order to determine whether a biasable delay driver needs to be biased, a determination may be made as to whether a particular amount of delay necessitates the tuning of the biasable delay driver. To this end, FIG. 6 shows an exemplary flow process in accordance with an embodiment of the present invention. Initially, the amount of delay present from a clock source to an input of a biasable delay driver is determined (step 150). This determination may be made using simulated circuit measurements, simulation runs, etc. Next, a determination is made as to whether the determined amount of delay is less than a minimum delay (step 152). The minimum delay is discussed below with reference to FIG. 7.

If the determined amount of delay is less than the minimum delay, the biasable delay driver size is decreased by one unit (step 154) in order to slow down the signal output from the biasable delay driver. Thereafter, the flow process repeats itself from step 150.

If the determined amount of delay is not less than the minimum delay, a determination is made as to whether the determined amount of delay is greater than or equal to a maximum delay (step 156). The maximum delay is discussed below with reference to FIG. 7.

If the determined amount of delay is greater than the maximum delay, the biasable delay driver size is increased by one unit (step 158) in order to speed up the signal output from the biasable delay driver. Thereafter, the flow process repeats itself from step 150. However, if the determined amount of delay is not greater than the maximum delay, then the biasable delay driver is determined to be adequately biased (step 160).

Referring now to the exemplary flow process shown in FIG. 7, to determine the maximum and minimum delays, the delays along the paths from the clock source to the clock controlled elements are determined (step 170). If the longest path delay minus the shortest path delay is greater than one gate delay (one gate delay is the range of biasable delay of a particular biasable delay driver) (step 172), the minimum delay is set to be equal to the longest path delay minus one gate delay (step 174). However, if the longest path delay minus the shortest path delay is not greater than one gate delay (step 172), the minimum delay is set to be equal to the shortest path delay (step 176). In either case, the maximum delay is set to be equal to the minimum delay plus the minimum increment resulting from tuning a biasable delay driver (step 178).

For example, consider that the longest path delay is 200 ps, the shortest path delay is 170 ps, one gate delay is 20 ps, and the minimum increment resulting from tuning the biasable delay driver is 2 ps. Thus, initially, skew between a clock signal at the end of longest path and the clock signal at the end of the shortest path is 200 ps-170 ps, or 30 ps. Using the flow process shown in FIG. 7, because the longest path delay minus the shortest path delay, 30 ps, is longer than one gate delay (step 172), 20 ps, the minimum delay is set to be equal to the longest path delay minus one gate delay (step 174), i.e., 200 ps-20 ps, or 180 ps. Because the minimum increment resulting from tuning the biasable delay driver is 2 ps, the maximum delay is set to be equal to the minimum delay plus the minimum biasable delay driver increment (step 178), i.e., 180 ps+2 ps, or 182 ps. It follows that based on the newly determined minimum and maximum delays, the skew, using one or more biasable delay drivers, is forced to be between 180 ps and 182 ps, i.e., a skew less than or equal to 2 ps. Thus, skew is reduced from 30 ps to 2 ps.

Those skilled in other embodiments, in the case that the longest path delay minus the shortest path delay is greater than one gate delay, the minimum delay may be set to be equal to any value between the shortest path delay and the longest path delay depending on the range of sizes of available biasable delay drivers.

In other embodiments, if the difference in path delays between two paths is too large to effectively compensate for skew using one or more biasable delay drivers, a dummy load may be positioned at the end of the shorter delay path in order to reduce the difference in the path delays between the two paths.

Those skilled in the art will appreciate that one will have a larger range of choice of precision with more available differently sized biasable delay drivers.

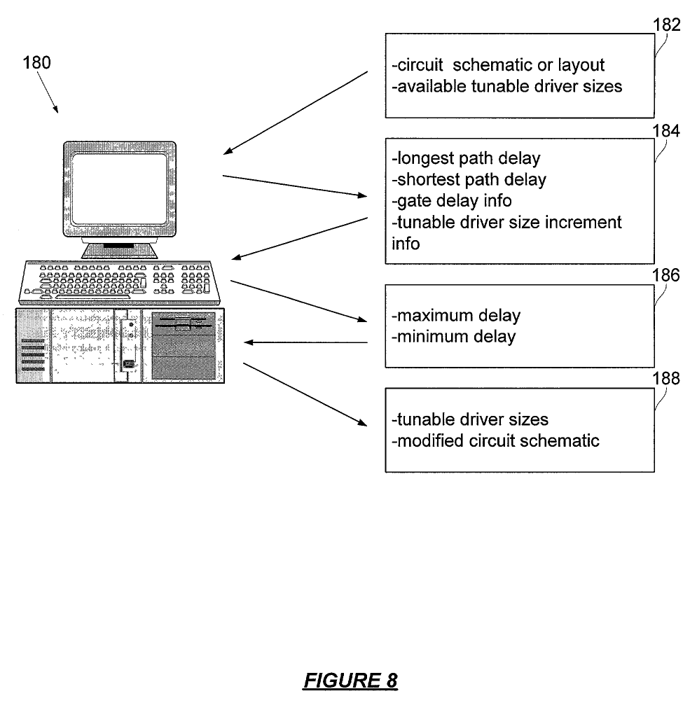

FIG. 8 shows an exemplary computer system (180) in accordance with an embodiment of the present invention. Input parameters (182) may include a circuit schematic or layout of a particular circuit that needs to be improved with respect to skew. Input parameters (182) may also include information regarding the range of sizes of available biasable delay drivers.

The input parameters (182) serve as input data to the computer system (180) via some computer-readable medium, e.g., network path, floppy disk, input file, etc. The computer system (180) then stores the input parameters (182) in memory (not shown) to subsequently determine (via microprocessor functions) a longest path delay and shortest path delay of the circuit (184). The computer system (180) may also determine gate delay information and biasable delay driver size increment information (184). Using this information (184), the computer system (180) may then determine the maximum and minimum delays for the circuit (186). Thereafter, using the maximum and minimum delay information (186), the computer system (180) outputs, via some user-readable medium, e.g., monitor display, network path, etc., the appropriate size(s) of biasable delay driver(s) (188) that need to be used in the circuit in order to effectively reduce or eliminate skew present in the circuit. The computer system (180) may additionally output a modified circuit schematic that incorporates the selected biasable delay drivers.

Those skilled in the art will appreciate that in other embodiments, a software program capable of generating appropriate biasable delay driver sizes consistent with the various techniques presented in the present invention may be used.

Advantages of the present invention may include one or more of the following. In some embodiments, because a biasable delay driver may be used to modulate a clock signal, skew between two clock signals may be reduced or eliminated.

In some embodiments, because a biasable delay driver compensates for skew-procuring delay on a path, unbalanced loading induced skew among two or more paths may be reduced or eliminated.

In some embodiments, because a biasable delay driver compensates for skew-procuring delay on a path, RC wire delay induced skew among two or more paths may be reduced or eliminated.

In some embodiments, because skew may be reduced or eliminated using one or more biasable delay drivers, circuit performance is improved.

In some embodiments, because a biasable delay driver compensates for a difference in delay between two paths, a designer does not need to focus on equalizing loads on the two paths.

In some embodiments, because a biasable delay driver has a fixed size element at its output, a drive strength of the biasable delay driver may remain constant even when the biasable delay driver is biased.

In some embodiments, because wire delays may be biased using biasable delay drivers, there is no need to match wire lengths within an integrated circuit; thus, there is less wire, which, in turn, leads to less capacitance, which, in turn, leads to less power consumption.

In some embodiments, because wire delays may be biased using biasable delay drivers, wire delays may be easily matched by interchanging one or more biasable delay drivers; thus, reducing the need for rerouting and/or creating additional wire tracks and/or needing different biasable delay drivers.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An integrated circuit, comprising:
a clock source that outputs a clock signal, wherein the clock signal propagates down a first path; and
a first biasable delay driver that inputs the clock signal at a point on the first path, wherein the first biasable delay driver is selectively sized based on a delay of the clock signal from the clock source to the point on the first path.

2. The integrated circuit of claim 1, the first biasable delay driver comprising:
a first element that inputs the clock signal and outputs a modulated clock signal; and
a second element that inputs the modulated clock signal and outputs a delay biased clock signal, wherein a size of the first element is variable.

3. The integrated circuit of claim 2, wherein the second element has a fixed size.

4. The integrated circuit of claim 1, wherein the clock signal propagates down a second path, the integrated circuit further comprising:
a second biasable delay driver that inputs the clock signal at a point on the second path, wherein the second biasable delay driver is selectively sized based on a delay of the clock signal from the clock source to the point on the second path.

5. The integrated circuit of claim 4, wherein the second path has a resistive component and a capacitive component.

6. The integrated circuit of claim 4, wherein a load on the first path and a load on the second path is unbalanced.

7. The integrated circuit of claim 4, wherein an RC delay of the first path is not equal to an RC delay of the second path.

8. The integrated circuit of claim 4, wherein a length of the first path is not equal to a length of the of the second path.

9. The integrated circuit of claim 1, wherein the first path has a resistive component and a capacitive component.

10. The integrated circuit of claim 1, wherein the clock source is a clock header.

11. An integrated circuit, comprising:
means for propagating a clock signal from a clock source to a point on a signal path; and
means for inputting the clock signal at the point and outputting a delay biased clock signal based on a delay of the clock signal from the clock source to the point.

12. A method for reducing clock skew, comprising:
determining a first delay of a clock signal from a clock source to a point on a first path, wherein the clock signal propagates from the clock source to the point on the first path; and
selectively sizing a first biasable delay driver depending on the first delay, wherein the first biasable delay driver inputs the clock signal at the point on the first path.

13. The method of claim 12, wherein the first path has a resistive component and a capacitive component.

14. The method of claim 12, wherein the clock source is a clock header.

15. The method of claim 12, wherein selectively sizing the first biasable delay driver comprises:
determining whether the first delay is less than a minimum delay;
if the first delay is less than a minimum delay, decreasing a size of the first biasable delay driver.

16. The method of claim 15, wherein selectively sizing the first biasable delay driver further comprises:
determining whether the first delay is greater than a maximum delay;
if the first delay is greater than a maximum delay, increasing the size of the first biasable delay driver.

17. The method of claim 16, further comprising determining a second delay of a clock signal from the clock source to a point on a second path, wherein the clock signal propagates from the clock source to the point on the second path, wherein selectively sizing the first biasable delay driver further comprises:
defining the minimum delay, wherein defining the minimum delay comprises:
defining a longest delay, wherein the longest delay is the greater of the first delay and the second delay;
defining a shortest delay, wherein the shortest delay is the smaller of the first delay and the second delay;
determining whether the longest delay minus the shortest delay is greater than a gate delay;
if the longest delay minus the shortest delay is not greater than the gate delay, setting the minimum delay to be equal to a value between the shortest delay and the longest delay depending on a range of available sizes of the first biasable delay driver,
defining the maximum delay, wherein the maximum delay is equal to the minimum delay plus an increment of the first biasable delay driver.

18. The method of claim 16, further comprising determining a second delay of a clock signal from the clock source to a point on a second path, wherein the clock signal propagates from the clock source to the point on the second path, wherein selectively sizing the first biasable delay driver further comprises:
defining the minimum delay, wherein defining the minimum delay comprises:
defining a longest delay, wherein the longest delay is the greater of the first delay and the second delay;
defining a shortest delay, wherein the shortest delay is the smaller of the first delay and the second delay;
determining whether the longest delay minus the shortest delay is greater than a gate delay;
if the longest delay minus the shortest delay is greater than the gate delay, setting the minimum delay to be equal to the longest delay minus the gate delay; and
if the longest delay minus the shortest delay is not greater than the gate delay, setting the minimum delay to be equal to the shortest delay,
defining the maximum delay, wherein the maximum delay is equal to the minimum delay plus an increment of the first biasable delay driver.

19. The method of claim 18, further comprising:
selectively sizing a second biasable delay driver depending on the second delay, wherein the second biasable delay driver inputs the clock signal at the point on the second path.

20. The method of claim 18, wherein the second path has a resistive component and a capacitive component.

21. The method of claim 18, wherein a load on the first path and a load on the second path is unbalanced.

22. The method of claim 18, wherein an RC delay of the first path is not equal to an RC delay of the second path.

23. The method of claim 18, wherein a length of the first path is not equal to a length of the of the second path.

24. A computer system, comprising:
a processor;
a memory; and
instructions, residing in the memory and executable by the processor, for:
determining a first delay of a clock signal from a clock source to a point on a first path, wherein the clock signal propagates from the clock source to the point on the first path; and
selectively sizing a first biasable delay driver depending on the first delay, wherein the first biasable delay driver inputs the clock signal at the point on the first path.

25. The computer system of claim 24, wherein the first path has a resistive component and a capacitive component.

26. The computer system of claim 24, wherein the clock source is a clock header.

27. The computer system of claim 24, wherein the instructions for selectively sizing the first biasable delay driver comprise instructions for:
determining whether the first delay is less than a minimum delay;
if the first delay is less than a minimum delay, decreasing a size of the first biasable delay driver.

28. The computer system of claim 27, wherein the instructions for selectively sizing the first biasable delay driver further comprise instructions for:
determining whether the first delay is greater than a maximum delay;
if the first delay is greater than a maximum delay, increasing the size of the first biasable delay driver.

29. The computer system of claim 28, further comprising instructions for determining a second delay of a clock signal from the clock source to a point on a second path, wherein the clock signal propagates from the clock source to the point on the second path, wherein the instructions for selectively sizing the first biasable delay driver further comprise instructions for:
defining the minimum delay, wherein defining the minimum delay comprises:
defining a longest delay, wherein the longest delay is the greater of the first delay and the second delay;
defining a shortest delay, wherein the shortest delay is the smaller of the first delay and the second delay;
determining whether the longest delay minus the shortest delay is greater than a gate delay;
if the longest delay minus the shortest delay is not greater than the gate delay, setting the minimum delay to be equal to a value between the shortest delay and the longest delay depending on a range of available sizes of the first biasable delay driver,
defining the maximum delay, wherein the maximum delay is equal to the minimum delay plus an increment of the first biasable delay driver.

30. The computer system of claim 28, further comprising instructions for determining a second delay of a clock signal from the clock source to a point on a second path, wherein the clock signal propagates from the clock source to the point on the second path, wherein the instructions for selectively sizing the first biasable delay driver further comprise instructions for:
defining the minimum delay, wherein defining the minimum delay comprises:
defining a longest delay, wherein the longest delay is the greater of the first delay and the second delay;
defining a shortest delay, wherein the shortest delay is the smaller of the first delay and the second delay;
determining whether the longest delay minus the shortest delay is greater than a gate delay;
if the longest delay minus the shortest delay is greater than the gate delay, setting the minimum delay to be equal to the longest delay minus the gate delay; and
if the longest delay minus the shortest delay is not greater than the gate delay, setting the minimum delay to be equal to the shortest delay,
defining the maximum delay, wherein the maximum delay is equal to the minimum delay plus an increment of the first biasable delay driver.

31. The computer system of claim 30, further comprising instructions for:
selectively sizing a second biasable delay driver depending on the second delay, wherein the second biasable delay driver inputs the clock signal at the point on the second path.

32. The computer system of claim 30, wherein the second path has a resistive component and a capacitive component.

33. The computer system of claim 30, wherein a load on the first path and a load on the second path is unbalanced.

34. The computer system of claim 30, wherein an RC delay of the first path is not equal to an RC delay of the second path.

35. The computer system of claim 30, wherein a length of the first path is not equal to a length of the of the second path.

36. A computer-readable medium having recorded therein instructions executable by processing, the instructions for:
determining a first delay of a clock signal from a clock source to a point on a first path, wherein the clock signal propagates from the clock source to the point on the first path; and
selectively sizing a first biasable delay driver depending on the first delay, wherein the first biasable delay driver inputs the clock signal at the point on the first path.

37. The computer-readable medium of claim 36, wherein the first path has a resistive component and a capacitive component.

38. The computer-readable medium of claim 36, wherein the clock source is a clock header.

39. The computer-readable medium of claim 36, wherein the instructions for selectively sizing the first biasable delay driver comprise instructions for:
determining whether the first delay is less than a minimum delay;
if the first delay is less than a minimum delay, decreasing a size of the first biasable delay driver.

40. The computer-readable medium of claim 39, wherein the instructions for selectively sizing the first biasable delay driver further comprise instructions for:
determining whether the first delay is greater than a maximum delay;
if the first delay is greater than a maximum delay, increasing the size of the first biasable delay driver.

41. The computer-readable medium of claim 40, further comprising instructions for determining a second delay of a clock signal from the clock source to a point on a second path, wherein the clock signal propagates from the clock source to the point on the second path, wherein the instructions for selectively sizing the first biasable delay driver further comprise instructions for:
defining the minimum delay, wherein defining the minimum delay comprises:
defining a longest delay, wherein the longest delay is the greater of the first delay and the second delay;
defining a shortest delay, wherein the shortest delay is the smaller of the first delay and the second delay;
determining whether the longest delay minus the shortest delay is greater than a gate delay;
if the longest delay minus the shortest delay is not greater than the gate delay, setting the minimum delay to be equal to a value between the shortest delay and the longest delay depending on a range of available sizes of the first biasable delay driver,
defining the maximum delay, wherein the maximum delay is equal to the minimum delay plus an increment of the first biasable delay driver.

42. The computer-readable medium of claim 40, further comprising instructions for determining a second delay of a clock signal from the clock source to a point on a second path, wherein the clock signal propagates from the clock source to the point on the second path, wherein the instructions for selectively sizing the first biasable delay driver further comprise instructions for:
defining the minimum delay, wherein defining the minimum delay comprises:
defining a longest delay, wherein the longest delay is the greater of the first delay and the second delay;
defining a shortest delay, wherein the shortest delay is the smaller of the first delay and the second delay;
determining whether the longest delay minus the shortest delay is greater than a gate delay;
if the longest delay minus the shortest delay is greater than the gate delay, setting the minimum delay to be equal to the longest delay minus the gate delay; and
if the longest delay minus the shortest delay is not greater than the gate delay, setting the minimum delay to be equal to the shortest delay,
defining the maximum delay, wherein the maximum delay is equal to the minimum delay plus an increment of the first bias able delay driver.

43. The computer-readable medium of claim 42, further comprising instructions for:
selectively sizing a second biasable delay driver depending on the second delay, wherein the second biasable delay driver inputs the clock signal at the point on the second path.

44. The computer-readable medium of claim 42, wherein the second path has a resistive component and a capacitive component.

45. The computer-readable medium of claim 42, wherein a load on the first path and a load on the second path is unbalanced.

46. The computer-readable medium of claim 42, wherein an RC delay of the first path is not equal to an RC delay of the second path.

47. The computer-readable medium of claim 42, wherein a length of the first path is not equal to a length of the of the second path.
